(19) United States
(12) Patent Application Publication
(10) Pub. No.: US 2013/0065664 A1
(43) Pub. Date: Mar. 14, 2013

(54) GAMING APPARATUSES AND METHODS INVOLVING ROTATING OF REELS

(71) Applicant: Sharra E. Clemens, Reno, NV (US)

(72) Inventor: Sharra E. Clemens, Reno, NV (US)

(73) Assignee: IGT

(21) Appl. No.: 13/231,658

(22) Filed: Sep. 13, 2011

(51) Int. Cl. A63F 13/00

(52) U.S. Cl. 463/20

(57) ABSTRACT

An exemplary embodiment relates to a method in a gaming system for playing a game. The method includes causing an output device to communicate a frame of play, the frame of play including symbols. Each symbol has a position within the frame of play. The method further includes establishing a first result of the game based on the position of the symbols and causing the output device to communicate an altered frame of play. Additionally, the method includes altering the position of at least one of the symbols within the frame of play to generate the altered frame of play. The method also includes establishing a second result of the game based on the altered frame of play.

### BACKGROUND

1. Field of the Described Embodiments

The described embodiments relate generally to gaming apparatuses and methods, such as gaming systems and methods deployed in a casino enterprise.

2. Description of the Related Art

Original reel-based slot machines used electro-mechanical slot-machine reels that physically spun during a game. In a modern video reel slot machine, a video monitor displays virtual “reels” that are electronically-generated depictions of electro-mechanical reels, in which spinning occurs via depiction on the video monitor. Reels are typically positioned horizontally or vertically, and appear parallel with other reels of the same size. Symbols appear on the reels such as cherries or other fruit, rectangles labeled “BAR”, diamonds, or the like.

A player-user generally initiates a game by placing a bet and pulling a lever or pushing a button. This causes the reels to spin. Once the reels stop, if the symbols on a “payline” are a winning combination of symbols, then the player-user wins the game. The payline is typically a line that crosses all of the reels, for the purpose of selecting one symbol from each reel. Collectively, these symbols determine the outcome of the game. For some machines, the payline is visible at all times, while in others, the payline is only displayed on the monitor after the reels have finished spinning A winning combination of symbols for a three-reel slot machine, for example, may be three diamonds. In a conventional three-reel slot machine, there are three vertical reels which spin the symbols so that the symbols appear to move from top to bottom, then out of view, eventually coming back into view as the reel wheel spins around. The payline may be a horizontal line across the middle of the portion of each reel that is visible to the player-user. In the three diamonds example, each reel would have stopped such that the payline is over the diamond symbol on each reel. In more complex video reel games, there is more than one payline, and the payline(s) may not necessarily be horizontal or vertical lines. For example, the payline(s) may be diagonal, the payline(s) may not be straight line(s), or the like.

### SUMMARY

An exemplary embodiment relates to a method in a gaming system for playing a game. The method includes causing an output device to communicate a frame of play, the frame of play including symbols. Each symbol has a position within the frame of play. The method further includes establishing a first result of the game based on the position of the symbols and causing the output device to communicate an altered frame of play. Additionally, the method includes altering the position of at least one of the symbols within the frame of play to generate the altered frame of play. The method also includes establishing a second result of the game based on the altered frame of play.

Another embodiment relates to a gaming system for playing a game. The gaming system includes means for communicating a frame of play and an altered frame of play. The frame of play includes symbols, each of the symbols having a position within the frame of play. The gaming system also includes means for establishing a first result of the game based on the position of the symbols and establishing a second result of the game based on the altered frame of play. The gaming system further includes means for altering the position of at least one of the symbols within the frame of play to generate the altered frame of play.

Another exemplary embodiment relates to a gaming apparatus including an output device for communicating information regarding a position of symbols. The gaming apparatus further includes a processor. The processor causes the output device to communicate a frame of play, the frame of play including symbols. Each symbol has a position with the frame of play. The processor establishes a first result of the game based on the position of the symbols. Further, the processor alters the position of at least one of the symbols within the frame of play to generate an altered frame of play. Additionally, the processor causes the output device to communicate the altered frame of play. The processor also establishes a second result of a game based on the altered frame of play.

In some embodiments, each of the at least one of the symbols appears symmetrical with respect to the vertical axis. In some embodiments, each of the at least one of the symbols appears symmetrical with respect to the horizontal axis.

According to some embodiments, the at least one of the symbols may include at least one vertical column of symbols. According to some embodiments, the at least one of the symbols may include at least one horizontal row of symbols. In some embodiments, the at least one of the symbols may include all symbols within the frame of play.

In some embodiments, altering the position includes rotating the at least one of the symbols about an axis. According to some embodiments, altering the position includes rotating the at least one of the symbols by 180 degrees.

In some embodiments, the output device includes at least one video display that displays the symbols. In some further embodiments, the processor causes the video display to illustrate that each of the at least one of the symbols appears to rotate.

According to some embodiments, a particular condition must be true for (a) the position of the at least one of the symbols to be altered, (b) the output device to communicate the altered frame of play, or (c) the second result of the game to be established. In some further embodiments, the particular condition is that a particular symbol is to be communicated to the output device. In some embodiments, the particular condition is that the altered frame of play would include at least one winning combination of symbols.

### BRIEF DESCRIPTION OF THE DRAWINGS

FIG. 1A is a schematic perspective view drawing of a gaming apparatus in accordance with an embodiment;

FIG. 1B is a general block diagram of a gaming apparatus in accordance with an another embodiment;

FIG. 2 is a flow diagram of a process according to yet another embodiment;

FIG. 3A is a generalized view of exemplary reels displayed by a gaming apparatus, before the entire reel set has changed its orientation, according to still another embodiment;

FIG. 3B is a generalized view of the exemplary reels of FIG. 3A, after the reel set has been rotated 180 degrees, according to another embodiment; and

FIG. 3C is a generalized view of the exemplary reels of FIG. 3A, after the reel set has been rotated about a vertical axis, according to a further embodiment.

FIG. 4A is a generalized view of exemplary reels displayed by a gaming apparatus, before the reels have been reversed, according to still another embodiment;

FIG. 4B is a generalized view of the exemplary reels of FIG. 4A, after the middle row has been reversed, according to another embodiment;

FIG. 4C is a generalized view of the exemplary reels of FIG. 4A, after the second column from the left has been reversed, according to a further embodiment;

FIG. 5A is a generalized view of exemplary reels displayed by a gaming apparatus, before some of the symbols have been rotated, according to still another embodiment; and

FIG. 5B is a generalized view of the exemplary reels of FIG. 5A, after some of the symbols have been rotated, according to another embodiment.

### DETAILED DESCRIPTION

Numerous specific details are set forth below to provide a thorough understanding of concepts underlying described embodiments. It will be apparent, however, to one skilled in the art that described embodiments may be practiced without some or all of these specific details. In other instances, well-known process steps have not been described in detail in order to avoid unnecessarily obscuring the underlying concepts.

Gaming apparatuses and methods may be described regarding reel games, such as video reel games. According to various embodiments, virtual reels may be “spun” and come to a stop, and whether symbols on reels form winning combination(s) may be determined based on payline(s) or other rules. As is discussed in more detail below, after that determination and before another game, in various embodiments, positions of symbols may change. One or more reels may appear to “flip” over, or rotate over, so that a position of symbols on a flipped or rotated reel may appear to be in a different orientation. In various embodiments, it may be determined whether there may be any new winning combination(s), based on new positions of symbols.

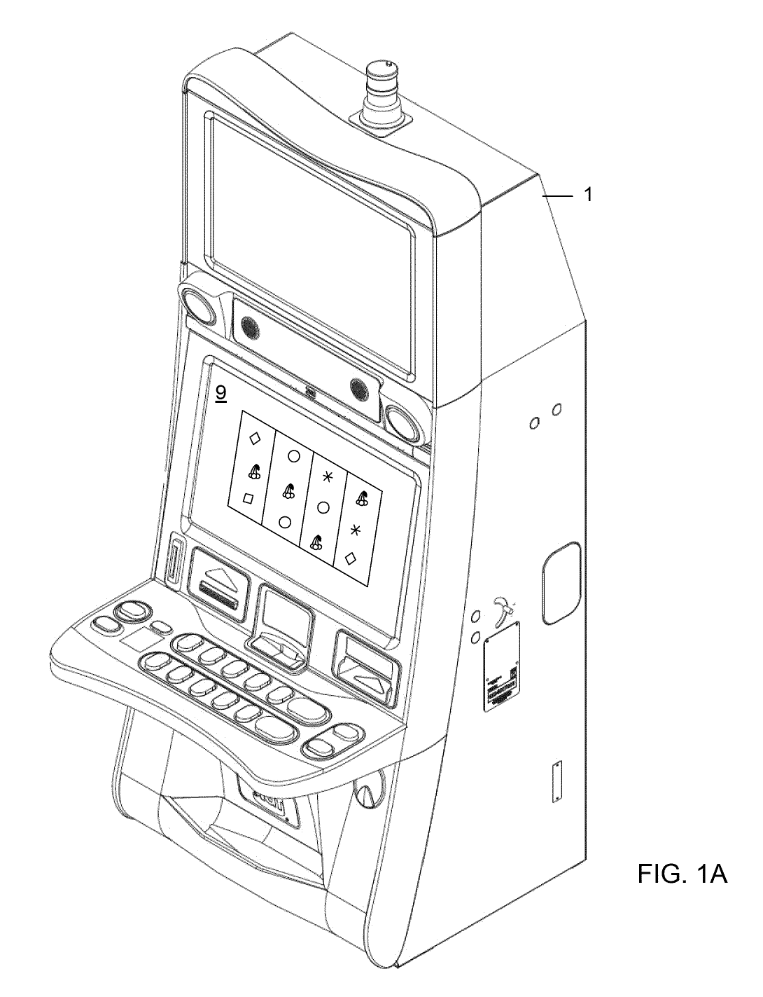

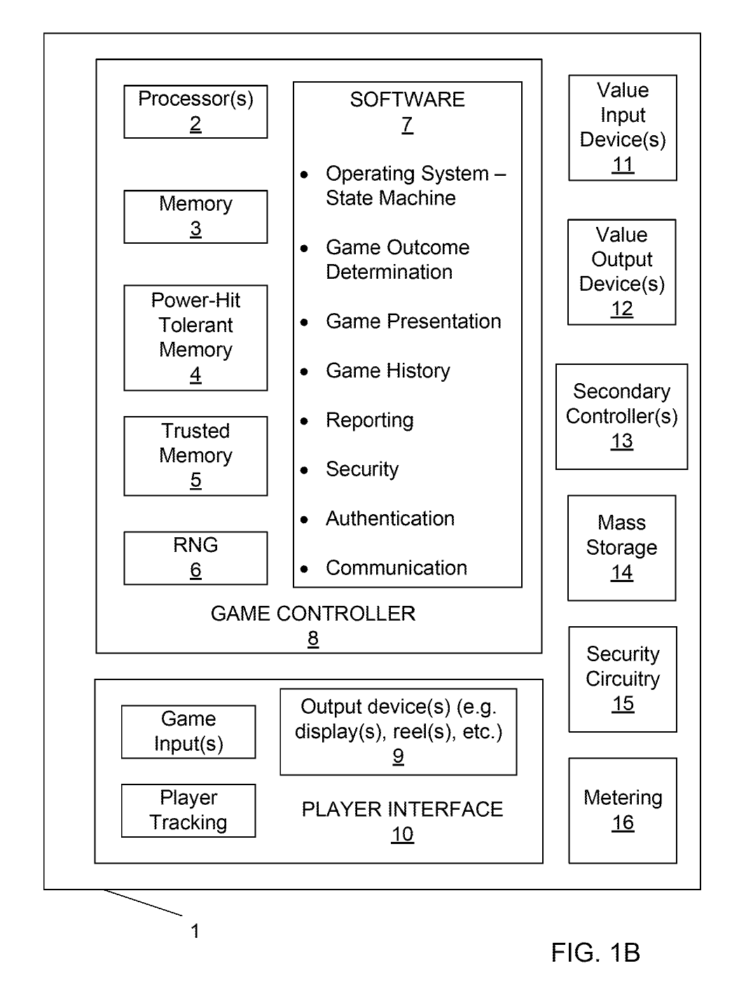

FIG. 1A illustrates a schematic perspective view drawing of a gaming apparatus 1 in accordance with an embodiment. According to various embodiments, a gaming apparatus 1 may be a slot-type gaming device, electronic gaming device, table gaming device, mobile gaming device, or the like. Gaming apparatus 1 may be capable of handling cash or gaming credits, or may allow users to play for free. Gaming apparatus 1 may communicate with one or more servers or apparatuses or may be standalone. Thus, features of gaming apparatus 1 may be described for purposes of illustration only and are not meant to be limiting.

FIG. 1B is a general block diagram of a gaming apparatus 1 in accordance with an embodiment. Gaming apparatus 1 may include a player interface 10 and a game controller 8. Gaming apparatus 1 may have a player interface 10 that allows input from a player-user, such as a wager amount, associated with a wager-based game to be played. A player interface 10 may facilitate communication of an outcome of a game or other information related to a game to a player-user. An outcome of a game may be displayed, shown, described, transmitted, or otherwise communicated to a player-user or another device through an output device 9.

An output device 9 may include one or more electro-mechanical reels, video displays, any visible or audible devices that may disclose or describe an outcome of a game, network devices that may communicate an outcome of a game to another device, or the like. Electro-mechanical reels, depictions of reels illustrated on a display, or any depictions of symbols in row(s), column(s), line(s), arc(s), or other patterns may be referred to herein as “reels” 9 for simplicity. Thus, it may be to be understood that a use of a term “reels” herein is not limiting. A video display 9 may be a liquid crystal display, cathode ray tube, plasma display, or other device for providing visual output.

In various embodiments, a gaming apparatus 1 may include a game controller 8 for controlling a wager-based game that may be played on a gaming apparatus 1. A game controller 8 may include one or more processors 2, memory 3 for holding data and software executed by one or more processors 2, power-hit tolerant memory 4, trusted memory 5, a random or pseudo-random number generator (RNG) 6, and software application(s) 7. One or more of a components of a game controller 8 and/or one or more of a components of a player interface 10 may be coupled, directly or indirectly, by a system bus.

With reference to FIG. 1B, according to some embodiments, a gaming apparatus 1 may include one or more value input devices 11 and one or more value output devices 12. Value input devices 11 may be used to deposit cash or indicia of credit onto a gaming device. Cash or indicia of credit may be used to make wagers on games played on a gaming apparatus 1. Examples of value input devices 11 include a magnetic-striped card, smart card reader, bill and/or ticket acceptor, network interface for downloading credits from a remote source, wireless communication interface for reading credit data from nearby devices and/or a coin acceptor.

Value output device(s) 12 may dispense cash, indicia of credit, or the like from a gaming apparatus 1. Examples of value output devices 12 include a network interface for transferring credits into a remote account, wireless communication interface that may be used with a mobile device implementing mobile wallet application(s), coin hopper for dispensing coins or tokens, bill dispenser, card writer, and/or printer for printing tickets or cards redeemable for cash or credits. Another type of value output device 12 is a merchandise dispenser, which may dispense merchandise with a tangible value from a gaming apparatus 1.

In some embodiments, a gaming apparatus 1 does not include a value input device 11 or a value output device 12. For instance, a thin-client gaming device that may be used in a mobile gaming application may use a remote account to maintain credits or amounts won or lost. An account may be accessed directly or indirectly by a gaming apparatus 1 such that an account balance may be adjusted as a result of game play on a gaming apparatus 1. In other embodiments, there may be no value input device 11 and/or a value output device 12 because a gaming apparatus 1 may be meant for free play and not wagering.

According to some embodiments, a gaming apparatus 1 may include one or more secondary controllers 13. Secondary controller(s) 13 may be associated with various peripheral device(s) that may be coupled to a gaming apparatus 1, such as value input device(s) 11 and value output device(s) 12. A secondary controller(s) 13 may be associated with peripheral devices associated with a player interface 10, such as input devices, video displays 9, electro-mechanical displays 9, and/or a player tracking unit. In some embodiments, a secondary controller(s) 13 may receive instructions and/or data from, and may provide responses to, a game controller 8. A secondary controller(s) 13 may interpret instructions and/or data from a game controller 8 and may control a particular device according to received instructions and/or data. For instance, a print controller may receive a print command with a number of parameters, such as a credit amount and, in response, may print a ticket redeemable for a credit amount. In another example, a touch screen controller may detect touch inputs and may send information to a game controller 8 that may characterize a touch input.

According to some embodiments, a secondary controller 13 may control a number of peripheral device(s) independently of a game controller 8. For instance, a player tracking unit may include one or more of a video display 9, a touch screen 9, card reader, network interface, and/or input buttons. A player tracking controller may control these devices to provide player tracking services and bonusing on a gaming apparatus 1. In some alternate embodiments, a game controller 8 may control these devices to perform player tracking functions.

In various embodiments, functions of a gaming apparatus 1 that may not be subject to as much regulatory scrutiny as game play functions may be decoupled from a game controller 8 and implemented on a secondary controller 13 instead. An advantage of this approach may be that software approval process for software executed by a secondary controller 13 may be less intensive than a process that may be needed to get software approved for a game controller 8.

According to some embodiments, one or more mass storage unit(s) 14, such as a device including a hard drive, optical disk drive, flash memory, or some other memory storage technology may be used to store applications and data used and/or generated by a gaming apparatus 1. For instance, in some embodiments, a mass storage unit 14 may be used to store gaming applications executed by a game controller 8 that may have been downloaded from remote device(s), such as a server. A game controller 8 may include its own dedicated mass storage unit 14. In other embodiments, critical data, such as game history data, may be stored in a power-hit tolerant memory 4, may be moved from a power-hit tolerant memory 4 to a mass storage unit 14 at periodic intervals for archival purposes and/or to free up space in a power-hit tolerant memory 4.

In various embodiments, a gaming apparatus 1 may include security circuitry 15, such as security sensors and circuitry for monitoring sensors. Security circuitry 15 may operate while a gaming device 1 is receiving direct power and may be operational to provide game play, as well as when a gaming apparatus 1 is uncoupled from direct power, such as during shipping or in an event of a power failure. A gaming apparatus 1 may be equipped with one or more secure enclosures, which may or may not include locks for limiting access to enclosures. One or more sensors may be located within secure enclosures or coupled to locks. Sensors may generate signals that may be used to determine whether secure enclosures have been accessed, locks have been actuated or a gaming apparatus 1 has been moved to an unauthorized area. Security monitoring circuitry may generate, store, and/or transmit error events when a security event, such as accessing an interior of a gaming device, has occurred. In some further embodiments, an error event may cause a game controller 8 to place itself in a “safe” mode such that no game play may be allowed until an error event is cleared.

According to various embodiments, a gaming apparatus 1 may include a metering function 16. A metering function 16 keeps track of information relating to betting frequency, betting patterns, and/or betting amount(s) of a player-user or player-users of a gaming apparatus 1. A metering function 16 may increment a game play meter as each game is played. A recent play meter may be incremented for each recent game played. A recent play meter may reset for a new session, new time period, or the like. An accumulated wager meter may track an amount wagered during recent play.

In various embodiments, the gaming apparatus 1 utilizes a “state” machine architecture. In a state machine architecture, critical information in each state may be identified and queued for storage to persistent memory. The architecture may not advance to the next state from a current state until all of the critical information that is queued for storage for the current state is stored to persistent memory. Thus, if an error condition occurs between two states, such as a power failure, the gaming apparatus 1 implementing the state machine can likely be restored to its last state prior to the occurrence of the error condition using the critical information associated with its last state stored in persistent memory. This feature is often called a “roll back” of the gaming device. Examples of critical information may include an outcome determined for a game, a wager amount made on the game, an award amount associated with the outcome, credits available, and/or an amount of credits deposited to the gaming apparatus 1.

A processing unit 2 may include one or more electronic processors that (through hardware, software, or both) perform functions described herein. A processing unit 2 (processor) may output information to an output device 9. There may be just one processor 2 in a gaming apparatus 1, or multiple processors 2. In some embodiments involving multiple processors 2, processors 2 may be in the same gaming apparatus 1 or may be distributed among a network of gaming apparatus(es) 1, server(s), and/or other devices.

In various embodiments, memory 3 may be any non-transient data-storage device that may store data which may thereafter be read by a system that executes software 7. Examples of memory 3 may include read-only memory (ROM), random-access memory (RAM), CD-ROMs, DVDs, electrically erasable programmable read-only memory (EEPROM), field programmable gate array (FPGA), flash memory, compact disk, magnetic tape, magnetic disk, or other magnetic storage devices, or optical data-storage devices, or the like. A memory 3 may be distributed over network-coupled systems so that software 7 may be stored and executed in a distributed fashion. A non-transient memory 3 may include volatile memory, non-volatile memory, and/or combinations of volatile and non-volatile memory.

According to various embodiments, a power-hit tolerant memory 4 may be used as persistent memory for critical data, such as critical data associated with maintaining a state machine on a gaming apparatus 1. One characteristic of a power-hit tolerant memory 4 may be a fast data transfer time. Thus, in an event of a power-failure, which might be indicated by a sudden power fluctuation, critical data may be quickly loaded from volatile memory, such as RAM associated with a processor 2, into a power-hit tolerant memory 4 and saved.

In some embodiments, a gaming apparatus 1 detects power fluctuations and, in response, triggers a transfer of critical data from RAM to a power-hit tolerant memory 4. One example of a power-hit tolerant memory 4 may be a battery-backed RAM. A battery supplies power to a normally volatile RAM so that in the event of a power failure, data loss may be avoided. Thus, a battery-backed RAM may also be referred to as a nonvolatile RAM or NV-RAM. An advantage of a battery-backed RAM may be that fast data transfer times associated with a volatile RAM may be obtained.

In various embodiments, a trusted memory 5 may be ROM of some type that may be designed to be unalterable. An EPROM or EEPROM are two types of memory that may be used as a trusted memory 5. Alternatively, other types of memories, such as Flash memory, may be utilized as an unalterable memory. A gaming apparatus 1 may include one or more trusted memories.

Prior to installation, contents of a trusted memory 5 may be verified. For instance, a unique identifier, such as a hash value, may be generated on contents of memory and then compared to an accepted hash value for contents of memory. Memory may not be installed if generated and accepted hash values do not match. After installation, a gaming apparatus 1 may check contents of a trusted memory 5. For instance, a unique identifier, such as a hash value, may be generated on contents of a trusted memory 5 and compared to an expected value for a unique identifier. If a generated value of a unique identifier and an expected value of a unique identifier do not match, then an error condition may be generated on a gaming apparatus 1. An error condition may result in a gaming apparatus 1 entering a “tilt” state in which game play may be temporarily disabled on a gaming apparatus 1.

Sometimes, verification of software executed on a gaming apparatus 1 may be performed by a regulatory body, such as a government agency. Often software used by a game controller 8 may be highly regulated, where only software approved by a regulatory body may be allowed to be executed by a game controller 8. In some embodiments, a trusted memory 5 may store authentication programs and/or authentication data for authenticating contents of various memories on a gaming apparatus 1. For instance, a trusted memory 5 may store an authentication program that may be used to verify contents of a mass storage device, which may include software executed by a game controller 8.

According to various embodiments, RNG 6 may be used to generate random or pseudo-random numbers for use in determining outcomes for a game of chance played on a gaming apparatus 1. In an exemplary embodiment of a mechanical or video slot reel type of game, an RNG 6, in conjunction with a paytable that lists possible outcomes for a game of chance and associated awards for each outcome, may be used to generate random or pseudo-random numbers for determining reel positions that display randomly-determined outcome(s) for a game. As described above, an outcome(s) generated on a gaming apparatus 1 may be considered critical data. Thus, in various embodiments, generated outcome(s) may be stored to a power-hit tolerant memory 4.

Not all gaming apparatuses 1 generate their own game outcomes and thus, may not use an RNG 6 for this purpose. Game outcomes may be generated on a remote device, such as server, and then transmitted to a gaming apparatus 1 where an outcome and an associated award may be displayed to a player-user via a player interface 10.

In other embodiments, a gaming apparatus 1 may be used to play central-determination games. In a central-determination game, a pool of game outcomes may be generated and then, particular game outcomes may be selected as needed (e.g., in response to a player-user requesting to play a central-determination game) from a pool of previously-generated outcomes. Next, in response to a request to play a central-determination game on gaming apparatus 1, an outcome from a pool may be downloaded to a gaming apparatus 1. A game presentation including a downloaded outcome may be displayed on a gaming apparatus 1.

In other embodiments, a thin-client type gaming apparatus 1, such as a mobile gaming device, may receive at least one game outcome from a remote device and not use RNG 6 to generate game outcomes locally. A game outcome may be generated remotely in response to inputs made on a mobile device, such as an input indicating a wager amount and/or an input to initiate a game. This information may be sent from a mobile device to a remote device. After receiving a game outcome from a remote device, a game presentation for a game outcome generated remotely may be generated and displayed on a mobile device. A game presentation may be generated remotely and then streamed for display to a mobile device.

A game controller 8 may utilize and execute many different types of software applications 7. Typically, software applications 7 utilized by a game controller 8 may be highly regulated and may undergo a lengthy approval process before a regulatory body allows software applications 7 to be utilized on a gaming apparatus 1 deployed in the field, such as in a casino. One type of software application 7 that a game controller may utilize may be an Operating System (OS). An OS allows various programs to be loaded for execution by a processor 2, such as programs for implementing a state machine on a gaming apparatus 1. Further, an OS may be used to monitor resource utilization on a gaming apparatus 1. For instance, certain applications, such as applications associated with game outcome generation and game presentation that may be executed by an OS, may be given higher priority to resources, such as a processor 2 and memory 3, than other applications that may be executing simultaneously on a gaming device.

As previously described, a gaming apparatus 1 may execute software 7 for determining an outcome of a game and generating a presentation of a determined game outcome including displaying an award for a game. As part of a game outcome presentation, one or more of 1) electro-mechanical devices, such as reels or wheels, may be actuated, 2) video content may be output to video displays, 3) sounds may be output to audio devices, 4) haptic responses may be actuated on haptic devices or 5) combinations thereof, may be generated under control of a game controller 8. Peripheral devices that may be used to generate components of a game outcome presentation may be associated with a player interface 10, and types of devices that may be utilized for a player interface 10 vary from device to device.

While a gaming device may have been described in connection with FIGS. 1A and 1B, it will be appreciated that embodiments may be used in a context of games played on other computing devices. A computing device may be any general-purpose or special-purpose computerized device such as a desktop computer, laptop computer, PDA, smartphone, cell phone, tablet computer, thin client device, thick client device, or the like.

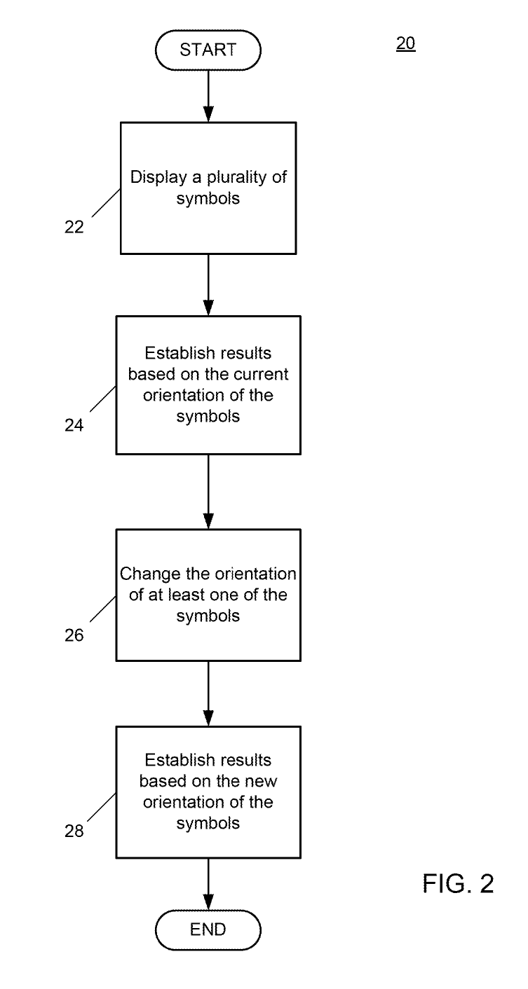

A generalized example of a process 20 carried out by a gaming apparatus 1 is described with reference to FIG. 2. Process 20 may be implemented in one or more software modules, routines, or programs. In step 22, a plurality of symbols may be displayed on an output device 9. Symbols may appear on a reel or set of reels of a slot machine or another device. In some embodiments, reels may be “spun” and come to a stop. Alternatively, reels may be displayed without having visibly spun.

In step 24, results may be established based on an orientation of symbols, using a processor 2. Positions of symbols may determine an outcome of a game. In some embodiments, if symbols on a payline(s) are a winning combination of symbols or a winning symbol, then a player-user wins. In some embodiments, there may be no visible payline. A winning combination of symbols may include any number of symbols. A winning combination may be any number of matching symbols, or may include particular pattern(s) of symbols such that symbols may or may not match each other, or the like.

In step 26, an orientation of at least one symbol may be changed, using a processor 2, and displayed on an output device 9. An entire reel set may appear to “flip” or rotate over, so that after flipping, symbols appear in a different orientation as viewed by a player-user, but in the same position relative to each other. An entire set of reels may be rotated in an x-y plane. For example, a reel set may be rotated 90 degrees, 180 degrees, or by any number of degrees. For instance, if a reel set is rotated 180 degrees in an x-y plane, a reel set may appear to a player-user as if it had been turned upside-down on a display. Alternatively, a reel set may be rotated around a vertical axis, from right-to-left or left-to-right. Or, a reel set may be rotated around a horizontal axis, from top-to-bottom or bottom-to-top.

In some embodiments, one or more symbols may be symmetrical so that they appear the same before and after being rotated upside-down or otherwise reversed across an axis, vertical, horizontal, or another axis.

In step 28, additional results may be established based on a new orientation of symbols, using a processor 2. This step may be similar to step 24, except results may be based on a new position(s) of symbols, after an orientation of at least one symbol may have been changed. In various embodiments, a player-user may (or may not) win based on a first result in step 24 and may (or may not) win again (or for a first time) based on a second result in step 28. Thus, if a player-user had placed a wager on a game, a player-user may win more than an amount won in step 24 alone.

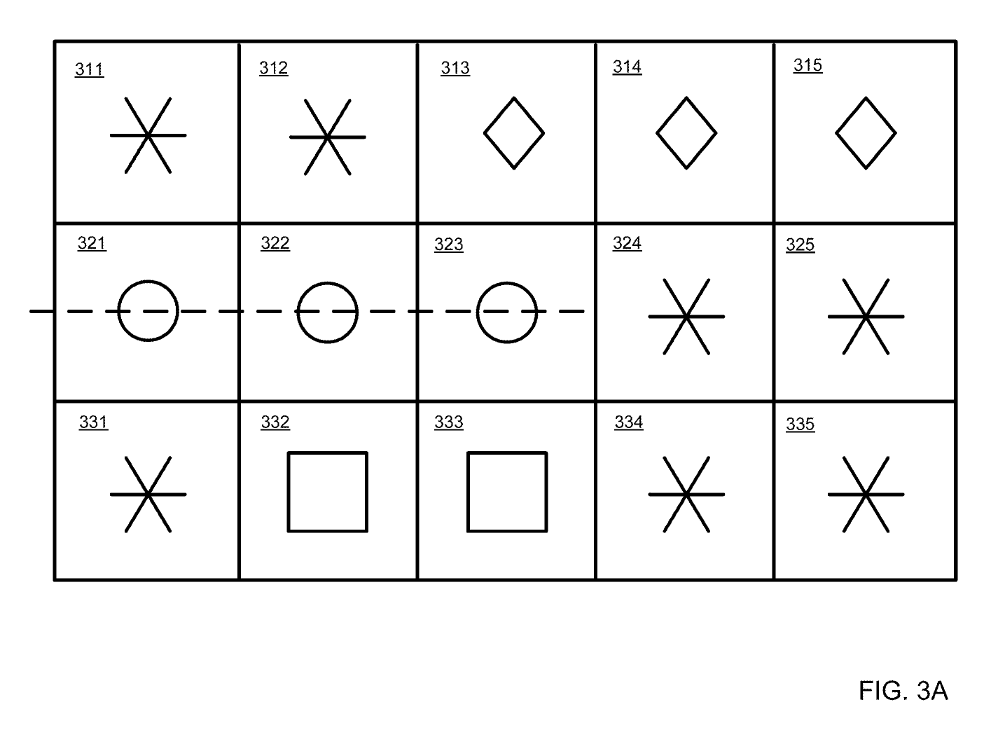

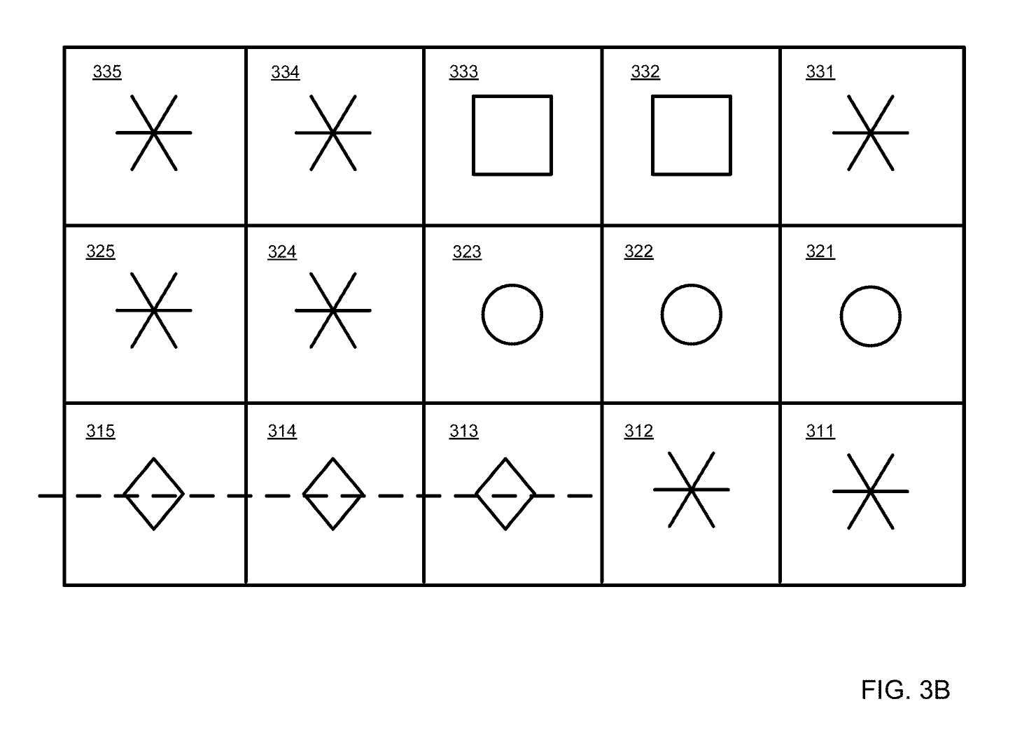

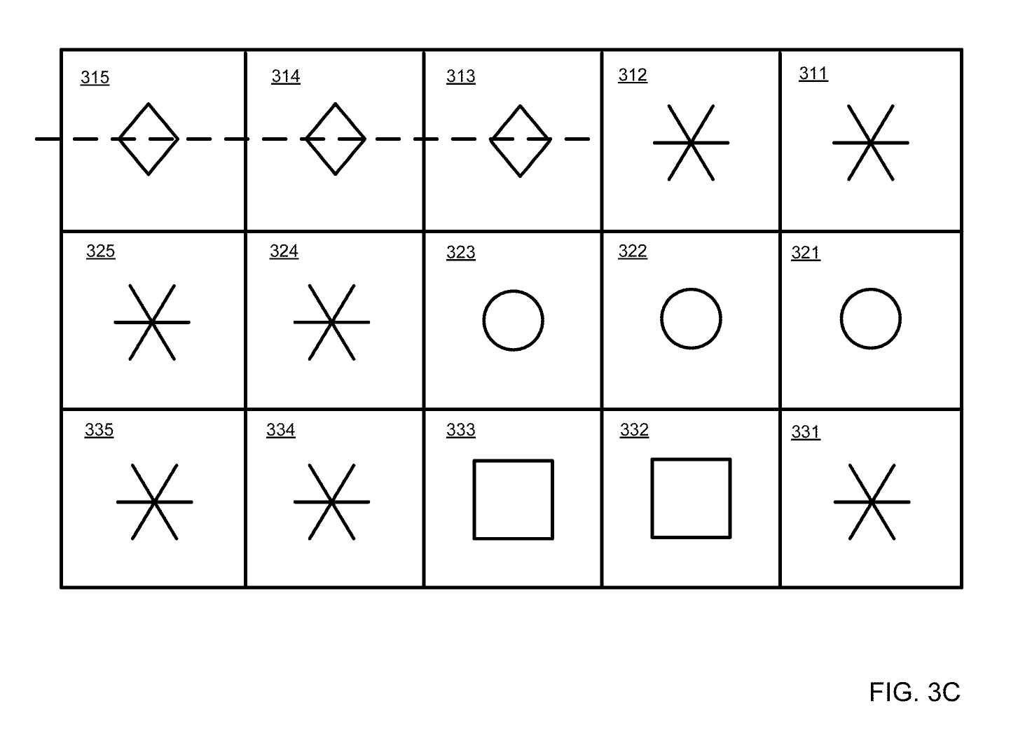

FIGS. 3A-3C illustrate an exemplary embodiment. FIG. 3A illustrates the portion of the display 9 of a video reel slot machine 1 that displays the reels and their symbols 311-335. FIG. 3A shows the positions that the symbols 311-335 are in after the reels have stopped spinning According to the sample game of FIGS. 3A-3C, winning combinations may be those in which at least three symbols in a row match, such that one of the matching symbols is in the left-most column 311, 321, 331. Thus, there is a winning combination in FIG. 3A because symbols 321, 322, 323 match, and matching symbol 321 is in the left-most column 311, 321, 331. This winning combination is marked in FIG. 3A with a broken line, representing a payline.

Then, in FIG. 3B, the entire set of reels has been rotated 180 degrees in the x-y plane from their original position illustrated in FIG. 3A. This change in position allows the symbols 313, 314, 315 to form a winning combination of matching diamond symbols, marked with a broken line, representing a payline. The symbols 311-335 of the rotated reels are symmetrical across the horizontal axis so that each symbol appears the same as it did before it was rotated (though it is in a different position after rotation).

However, in FIG. 3C, the entire set of reels has been rotated along a vertical axis so that the order of those symbols 311-335 is now different from their original position illustrated in FIG. 3A. This change in position allows the symbols 313, 314, 315 to form a winning combination of matching diamond symbols, marked with a broken line, representing a payline. The symbols 311-335 of the rotated reels are symmetrical across the vertical axis so that each symbol appears the same as it did before it was rotated (though it is in a different position after rotation).

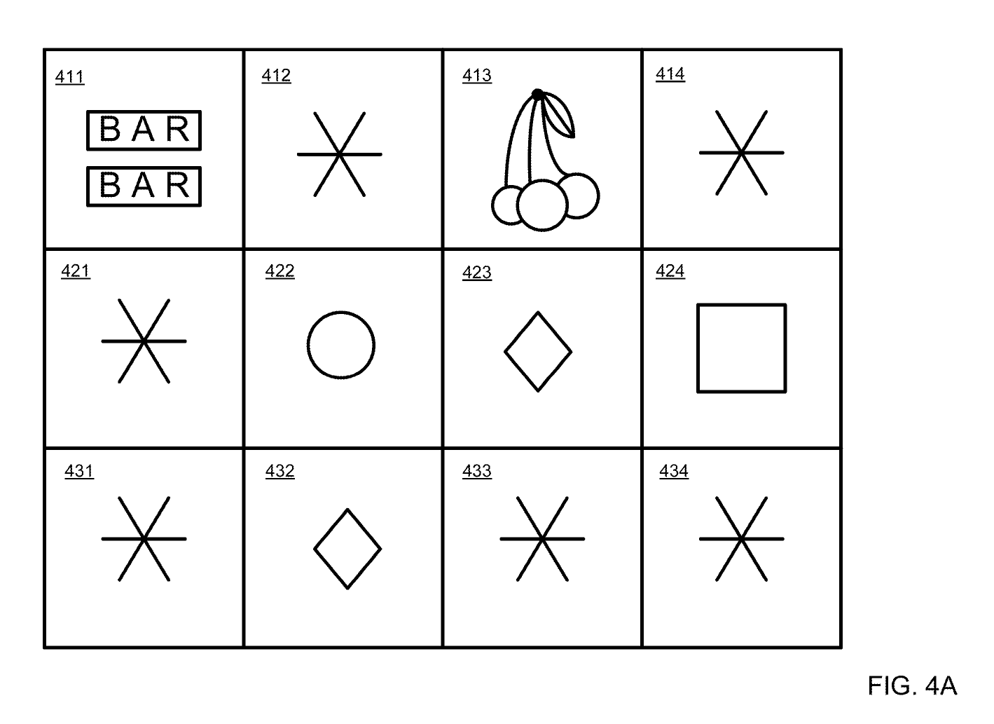

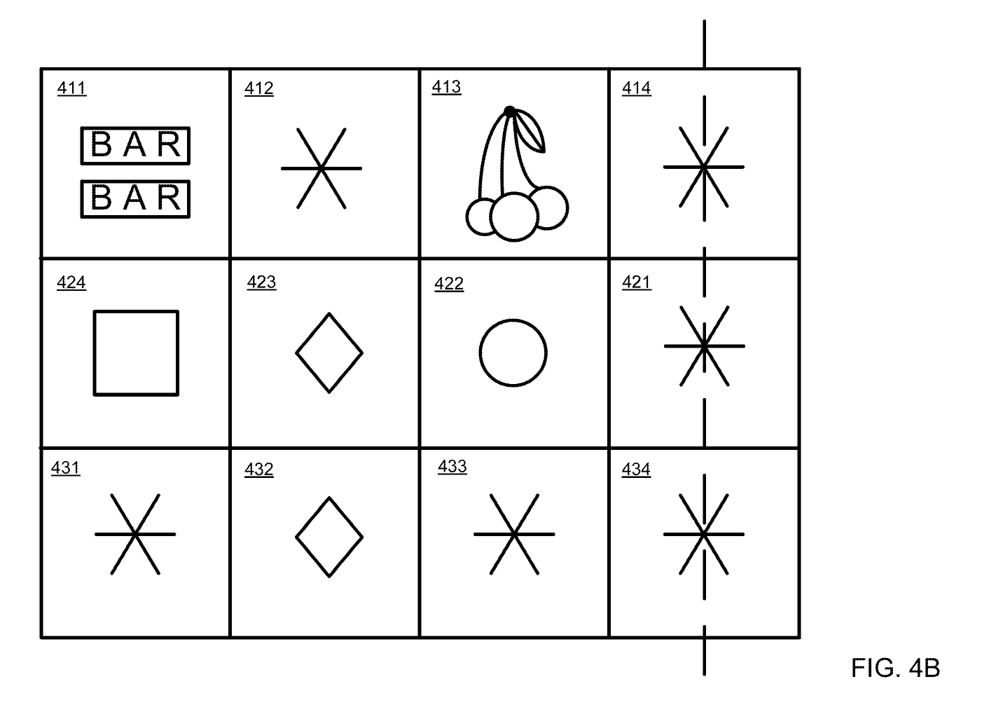

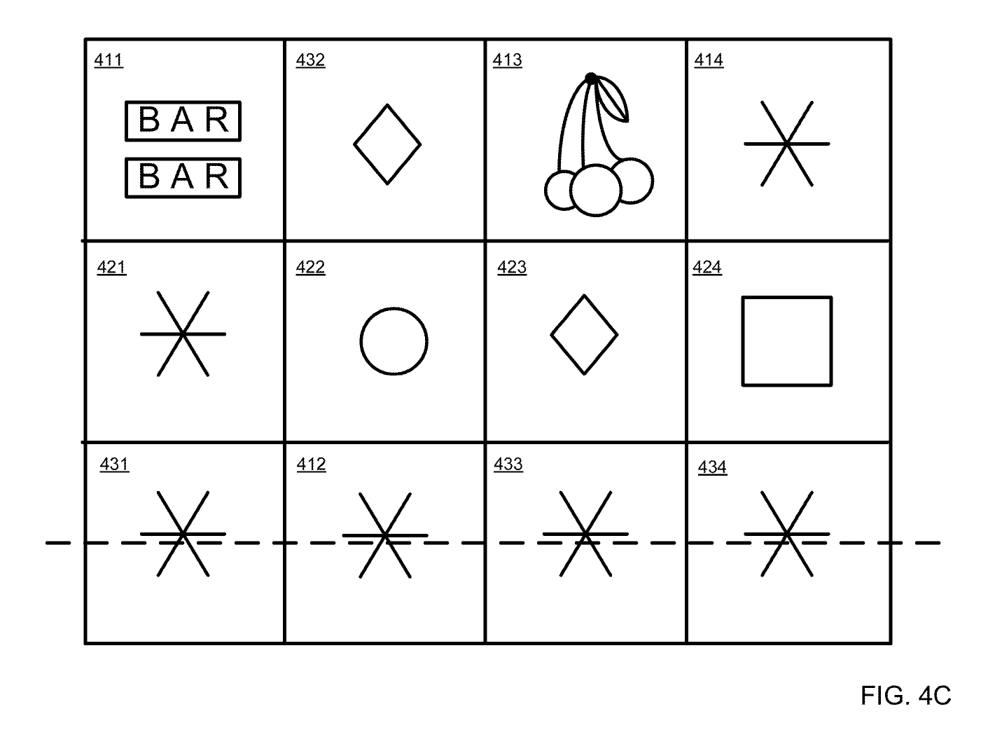

In some embodiments, such as an exemplary embodiment of FIGS. 4A-4C, step 26 involves rotating around or reversing a reel(s) so that its symbols may be in a same position relative to each other, but a new position relative to other, non-rotated reel(s). For example, for a horizontal reel with symbols “A”, “B”, and “C” (as read from left to right), after a reel may be reversed, a symbols may read “C”, “B”, “A” (from left to right). FIG. 4A illustrates a portion of a display 9 of a video reel slot machine 1 that may display reels and their symbols. FIG. 4A shows positions that symbols may be in after reels have stopped spinning According to a sample game of FIGS. 4A-4C, winning combinations may be those in which all symbols in a row (such as the top row 411, 412, 413, 414) or column (such as the first column 411, 421, 431) match. In that case, there would be no winning combination in FIG. 4A because no row or column contains all matching symbols.

However, in FIG. 4B, the middle row 421, 422, 423, 424 has been reversed so that the order of those symbols is now different from what it had been, relative to the top row 411, 412, 413, 414 and the bottom row 431, 432, 433, 434. This change in position of an asterisk symbol 421 allows the last column from the left 414, 421, 434 to form a winning combination of matching asterisk symbols, marked with a broken line, representing a payline. The symbols of the rotated row 421, 422, 423, 424 are symmetrical across the vertical axis so that when the row 421, 422, 423, 424 is rotated, each symbol 421, 422, 423, 424 appears the same as it did before it was rotated (though it is in a different position after rotation).

Similarly, in FIG. 4C, the second column from the left 412, 422, 432 has been reversed so that the order of those symbols is now different from what it had been in FIG. 4A, relative to the other columns. This change in position of an asterisk symbol 412 allows the bottom row 431, 412, 433, 434 to form a winning combination of matching asterisk symbols, marked with a broken line, representing a payline. The symbols of the rotated column 412, 422, 432 are symmetrical across the horizontal axis so that when the column 412, 422, 432 is rotated, each symbol 412, 422, 432 appears the same as it did before it was rotated (though it is in a different position after rotation).

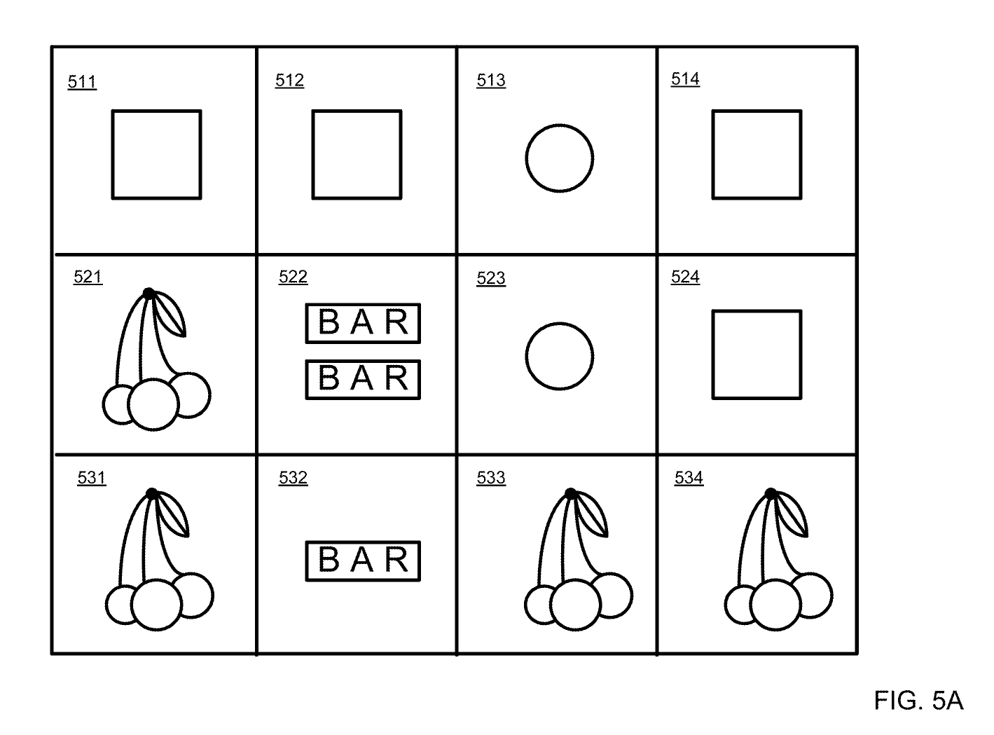

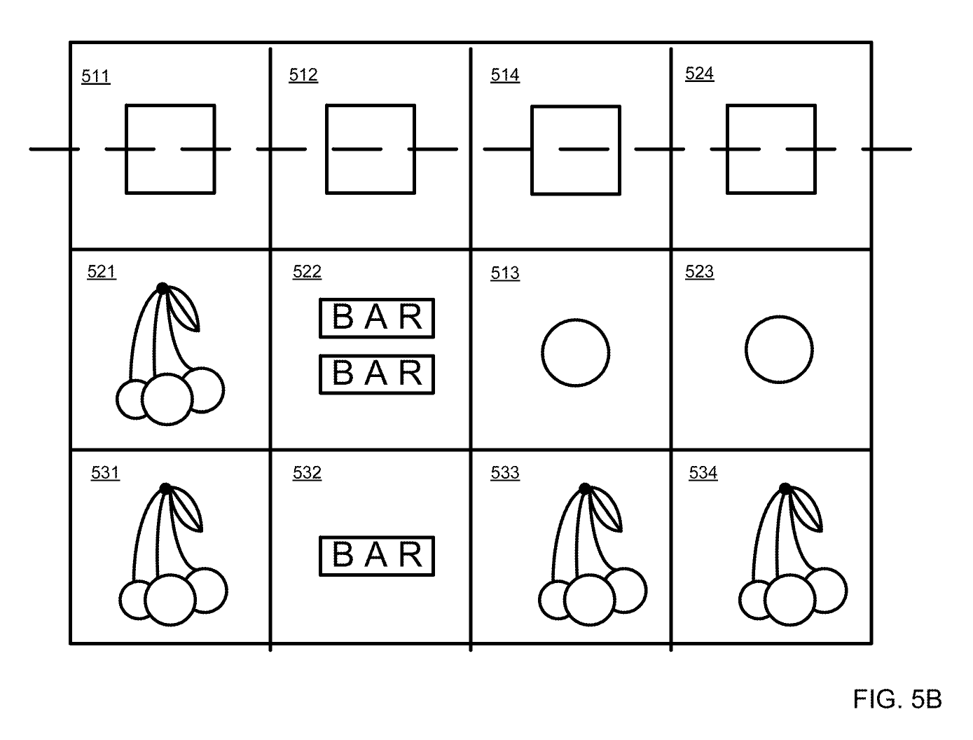

In some embodiments, such as an exemplary embodiment of FIGS. 5A-5B, step 26 involves rotating around a subset of symbols of a frame of play so that rotated symbols may be in a same position relative to each other, but a new position relative to other, non-rotated symbol(s). For example, symbols may be rotated clockwise or counter-clockwise about a point in an x-y plane. FIG. 5A illustrates a portion of a display 9 of a gaming machine 1 that may display a frame of play and its symbols 511-534. FIG. 5A shows positions that symbols 511-534 may be in when a first result of a game may be established. According to a sample game of FIGS. 5A-5B, winning combinations may be those in which all symbols in a row match. Thus, there may be no winning combination in FIG. 5A because no row contains all matching symbols.

However, in FIG. 5B, the symbols 513, 514, 523, 524 have been rotated counter-clockwise 90 degrees in the x-y plane about a point in the center of the symbols 513, 514, 523, 524 so that the order of those symbols is now different from what it had been, relative to the non-rotated symbols. This change in position, or altered frame of play, allows the top row 511, 512, 514, 524 to form a winning combination of matching square symbols, marked with a broken line, representing a payline. The rotated symbols 513, 514, 523, 524 are symmetrical across the horizontal and vertical axes so that each symbol 513, 514, 523, 524 appears the same before and after the rotation (though it is in a different position after rotation).

According to various embodiments, there may be one or more triggers that result in a processor 2 determining that step 26 should be reached (as opposed to having a game end at a completion of step 24). A particular symbol becoming visible on a reel may be a trigger. A set of reels displayed after a spin completes such that they show a possible winning combination may be a trigger. According to other embodiments, every game results in step 26 being reached.

Various hardware platforms may be utilized to implement process including games, systems, and cabinets manufactured by gaming suppliers as well as mobile and non-mobile computing devices. Various operating systems and screen types may be used without departing from the scope of the disclosure. In addition, the numbers and types of symbols and arrangement thereof as well as the arrangement of paylines is not shown in a limiting fashion.

Various aspects, embodiments, implementations or features of the described embodiments may be used separately or in any combination. Various aspects of the described embodiments may be implemented by software, hardware, or a combination of hardware and software.

The foregoing description, for purposes of explanation, used specific nomenclature to provide a thorough understanding of the disclosure. However, it will be apparent to one skilled in the art that the specific details are not required in order to practice the disclosure. Thus, the foregoing descriptions of specific embodiments are presented for purposes of illustration and description. They are not intended to be exhaustive or to limit the disclosure to the precise forms disclosed. It will be apparent to one of ordinary skill in the art that many modifications and variations are possible in view of the above teachings.

The embodiments were chosen and described in order to best explain the principles of the disclosure and its practical applications, to thereby enable others skilled in the art to best utilize the disclosure and various embodiments with various modifications as are suited to the particular use contemplated. It is intended that the scope of the disclosure be defined by the following claims and their equivalents.

While the embodiments have been described in terms of several particular embodiments, there are alterations, permutations, and equivalents, which fall within the scope of these general concepts. It should also be noted that there are many alternative ways of implementing the methods and apparatuses of the present embodiments. It is therefore intended that the following appended claims be interpreted as including all such alterations, permutations, and equivalents as fall within the true spirit and scope of the described embodiments.

What is claimed is:

1. A method in a gaming system for playing a game, comprising:
causing an output device to communicate a frame of play, the frame of play comprising symbols, wherein each of the symbols has a position within the frame of play;
establishing a first result of the game based on the position of the symbols;
altering the position of at least one of the symbols within the frame of play to generate an altered frame of play;
causing the output device to communicate the altered frame of play; and
establishing a second result of the game based on the altered frame of play.

2. The method of claim 1, wherein each of the at least one of the symbols appears symmetrical with respect to the vertical axis.

3. The method of claim 1, wherein each of the at least one of the symbols appears symmetrical with respect to the horizontal axis.

4. The method of claim 1, wherein the at least one of the symbols includes at least one vertical column of symbols.

5. The method of claim 1, wherein the at least one of the symbols includes at least one horizontal row of symbols.

6. The method of claim 1, wherein the at least one of the symbols includes all symbols within the frame of play.

7. The method of claim 1, wherein altering the position comprises rotating the at least one of the symbols about an axis.

8. The method of claim 1, wherein altering the position comprises rotating the at least one of the symbols by 180 degrees.

9. The method of claim 1, wherein the output device comprises at least one video display that displays the symbols.

10. The method of claim 9, further comprising:
causing the video display to illustrate that the at least one of the symbols appears to rotate.

11. The method of claim 1, wherein a particular condition must be true for (a) the position of the at least one of the symbols to be altered, (b) the output device to communicate the altered frame of play, or (c) the second result of the game to be established.

12. The method of claim 11, wherein the particular condition is that a particular symbol is to be communicated to the output device.

13. The method of claim 11, wherein the particular condition is that the altered frame of play would include at least one winning combination of symbols.

14. A gaming apparatus for playing a game, comprising:
an output device for communicating information regarding the position of symbols; and
a processor configured to:
cause the output device to communicate a frame of play, the frame of play comprising symbols, wherein each of the symbols has a position within the frame of play;
establish a first result of the game based on the position of the symbols;
alter the position of at least one of the symbols within the frame of play to generate an altered frame of play;
cause the output device to communicate the altered frame of play;
establish a second result of the game based on the altered frame of play.

15. The gaming apparatus of claim 14, wherein each of the at least one of the symbols appears symmetrical with respect to the vertical axis.

16. The gaming apparatus of claim 14, wherein each of the at least one of the symbols appears symmetrical with respect to the horizontal axis.

17. The gaming apparatus of claim 14, wherein the at least one of the symbols includes at least one vertical column of symbols.

18. The gaming apparatus of claim 14, wherein the at least one of the symbols includes at least one horizontal row of symbols.

19. The gaming apparatus of claim 14, wherein the at least one of the symbols includes all symbols within the frame of play.

20. The gaming apparatus of claim 14, wherein altering the position comprises rotating the at least one of the symbols about an axis.

21. The gaming apparatus of claim 14, altering the position comprises rotating the at least one of the symbols by 180 degrees.

22. The gaming apparatus of claim 14, wherein the output device comprises at least one video display that displays the symbols.

23. The gaming apparatus of claim 22, the processor further configured to:
cause the video display to illustrate that the at least one of the symbols appears to rotate.

24. The gaming apparatus of claim 14, wherein a particular condition must be true for (a) the position of the at least one of the symbols to be altered, (b) the output device to communicate the altered frame of play, or (c) the second result of the game to be established.

25. The gaming apparatus of claim 24, wherein the particular condition is that a particular symbol is to be communicated to the output device.

26. The gaming apparatus of claim 24, wherein the particular condition is that the altered frame of play would include at least one winning combination of symbols.

27. A gaming system for playing a game, comprising:
means for communicating a frame of play and an altered frame of play;
wherein the frame of play comprises symbols, wherein each of the symbols has a position within the frame of play;
means for establishing a first result of the game based on the position of the symbols and establishing a second result of the game based on the altered frame of play; and
means for altering the position of at least one of the symbols within the frame of play to generate the altered frame of play.

28. The gaming system of claim 27, wherein the at least one of the symbols includes all symbols within the frame of play.

29. The gaming system of claim 27, wherein altering the position comprises rotating the at least one of the symbols about an axis.

30. The gaming system of claim 27, wherein altering the position comprises rotating the at least one of the symbols by 180 degrees.
